(19) United States
(12) Patent Application Publication
(10) Pub. No.: US 2023/0186896 A1
(43) Pub. Date: Jun. 15, 2023

(54) SPEAKER VERIFICATION METHOD USING NEURAL NETWORK

(71) Applicant: My Voice AI Limited, London (GB)

(72) Inventors: Jennifer WILLIAMS, Edinburgh (GB); Moez AJILI, Plaisir (FR)

(21) Appl. No.: 17/552,161

(22) Filed: Dec. 15, 2021

(51) Int. Cl. G10L 15/02

(52) U.S. Cl. CPC G10L 15/02

(57) ABSTRACT

Methods for generating a vocal signature for a user and performing speaker verification on a device. The method comprises: receiving a vocal sample from a user; extracting a feature vector describing characteristics of the user’s voice from the vocal sample; and processing the feature vector using a trained neural network, wherein the processing comprises: inputting elements of the feature vector to a first convolutional layer; operating on the inputted elements with the first convolutional layer; performing max pooling using a first max pooling layer; operating on the activations of the first max pooling layer with a second convolutional layer; performing max pooling using a second max pooling layer; inputting activations of the second max pooling layer to a statistics pooling layer; and inputting activations of the statistics pooling layer to a fully-connected layer; extracting the activations of the fully-connected layer; and generating a vocal signature for the user.

### TECHNICAL FIELD

The present invention relates to a method of generating a vocal signature of a user, for the purposes of training a neural network, performing user enrolment and speaker verification with the generated vocal signature, a device and a system for implementing a trained neural network model on the device.

### BACKGROUND

Speaker recognition refers to the task of identifying a speaker from features of their voice. Applications of speaker recognition include speaker verification and speaker identification. Speaker verification involves comparing a vocal signature from an individual who claims to have a certain identity against a stored vocal signature known to be of the individual with the claimed identity, to determine if the identity of the presenting individual is as claimed. On the other hand, speaker identification is the task of determining if a speaker of unknown identity is a speaker that exists in a population of known speakers.

Recent advances in communications technology have given rise to the use of speaker verification in new settings, particularly in user experiences, such as to control an electronic device or to interact with a voice-controlled virtual assistant. These uses of speaker recognition benefit from implementing speaker verification by only allowing authorised, or enrolled users to use voice controlled functions. This improves the security of the functions, as their use is essentially locked behind speaker verification. Speaker verification is a resource intensive process in terms of the electrical power, processor time and memory required. Specifically, generating a vocal signature is computationally complex, as will be discussed below. Existing approaches require that the resource intensive aspects of speaker verification are performed in resource rich environments, for example in a cloud network. This ensures that speaker recognition can be performed accurately and quickly, in line with user expectations.

One existing approach to speaker recognition is to train a Gaussian mixture model (GMM) to parametrize a speech waveform and accordingly verify or identify the speaker. However, this approach is limited. The trained model requires a background model, and the speakers contained in the background model affects the overall performance of the trained GMM model. Another problem with the GMM approach is that it is computationally complex and slow, which prevents this approach from being widely adopted. Another approach is to use a hidden Markov model (HMM), which relies on stochastic state machines with a number of states to generate an acoustic model that can determine the likelihood of a set of acoustic vectors given a word sequence. However, this approach is especially resource intensive, and would be expensive to implement with the level of accuracy and speed that end users expect.

A commonly adopted approach to speaker recognition is to use i-vectors with support vector machines, also known as SVMs. An i-vector is a fixed dimension vectorial representation of a speech sample, which can be fed to a support vector machine to classify features of the i-vector, thereby classifying a speaker. This approach is a popular one due its simplicity, but is prone to error and performance loss when the speech sample is captured in less than perfect conditions.

A preferred approach to speaker recognition is to use a neural network model. The number of parameters needed to define a neural network model scales linearly with the number of nodes. Therefore, hundreds of thousands, if not millions of calculations must be performed each time a vocal signature is to be generated. The resources required to perform the calculations are significant.

Instead of addressing the issue that generating a vocal signature is resource intensive, an approach to performing speaker verification accurately using a neural network is to use as many resources as are needed. This includes processing a speech sample with a neural network formed of many layers, with a large number of nodes per layer. In addition, the neural networks are trained using large data sets. In some sense, this is a brute force approach. A reference vector, with high dimensionality, sometimes referred to as an x-vector, is produced. This acts as a unique identifier for the user’s voice. The high dimensionality of the reference vector is needed to characterize the user’s voice in great detail. A reference vector is analogous to a fingerprint, in that it is a unique identifier of a user.

An alternative form of the reference vector is a d-vector. The primary difference between an x-vector and a d-vector is that the d-vector was designed to be text-dependent whereas the x-vector is designed to be text-independent. This means that for models making use of a text dependent d-vector, the user must always speak the same phrase or utterance. On the other hand, using an x-vector allows the user to be identified by any phrase or utterance.

No matter which kind of reference vector is used, such powerful neural networks need large amounts of resources in terms of processing capabilities, electrical power, memory and training data to operate. This makes a standardized approach to speaker recognition using neural networks the only realistic option. It is less expensive to implement and maintain a single trained neural network model that is powerful enough to perform speaker recognition than it would be to implement and maintain any number of user specific neural network models capable of doing the same.

Often, the required resources for this kind of approach are found in cloud networks, where sufficient computing resources can be dedicated to performing speaker recognition. A neural network model hosted on the cloud is cheaper and easier to maintain, since any maintenance can be performed centrally. However, despite the supposed benefits of a cloud-based approach, a consequence is that a sample of the user’s voice must be sent off device, this risks the user’s sensitive information being intercepted by a malicious third-party.

Attempts at reducing the resource cost speaker verification using neural networks have been made. For example, to reduce the footprint of a neural network, certain layers that are only useful for training the neural network are discarded once training is complete. Subsequently, at inference time, the x-vector is produced by extracting the activations of one of the hidden layers. This approach leaves room for improvement; although the neural network model has been truncated, the remaining model is not modified. The lack of optimization becomes apparent when looking at the total number of parameters needed for the model to function, and the number of calculations performed by the model. Another indicator that further improvements are yet to be made is the high dimensionality of the resulting x-vector.

As well as the computational resource cost of the cloud network approach to speaker recognition, there is a carbon cost. Major factors which contribute to the carbon footprint of the cloud networking approach are the amount of electricity required to keep a server operational, as well as the amount of electricity needed to train or re-train the neural network model, especially if a large data set is used to perform the training. In addition, given that the cloud-based model performs millions of calculations each time speaker recognition is performed, the electricity cost to produce a reference vector is significant. Another factor that contributes significantly to the carbon footprint of a cloud network approach is the electricity needed to cool and maintain a server room.

Current approaches to speaker recognition are therefore limited in that they are resource intensive, generate a large carbon footprint, lack performance in many circumstances, and pose a risk to a user’s biometric data. The resource intensive nature of the above methods means that cloud networking approaches are a natural solution. As such, there is a need to provide a method of speaker recognition that can address these issues.

### SUMMARY OF THE INVENTION

A first aspect provides a method, performed by a device, of generating a vocal signature of a user. The device comprises a feature extraction module, a storage module, and a processing module. The method comprises: receiving, by the device, a vocal sample from a user; extracting, by the feature extraction module, a feature vector that describes characteristics of the user’s voice from the vocal sample; and processing, by the processing module, the feature vector using a trained neural network stored in the storage module, wherein the processing comprises: inputting elements of the feature vector to a first convolutional layer; operating on the input feature vector with the first convolutional layer; performing max pooling using a first max pooling layer; operating on the activations of the first max pooling layer with a second convolutional layer; performing max pooling using a second max pooling layer; inputting activations of the second max pooling layer to a statistics pooling layer; and inputting activations of the statistics pooling layer to a fully-connected layer; extracting the activations of the fully-connected layer; generating a vocal signature for the user, wherein elements of the vocal signature are based on the extracted activations, and wherein the vocal signature can be used to perform speaker verification.

Implementations provide a method for generating a vocal signature of a user, but with a reduced resource cost compared to previous solutions. The present method makes use of a reduced profile neural network. By this we mean that the neural network uses fewer layers, with the layers being arranged in such a way that the resulting vocal signature has fewer dimensions than seen in prior methods. Not only is the arrangement of the layers important, but since the neural network has fewer layers and nodes, the total number of parameters required by the neural network is reduced. Accordingly, the total number of calculations that must be performed to generate a vocal signature is also reduced. This is beneficial for reducing the total footprint, i.e. resources required, by the neural network model and the algorithm that implements the model. While the vocal signature may have fewer dimensions, this does not mean that the vocal signature is less robust or reliable. On the contrary, the vocal signature generated using the present method is suitably robust that it can reliably be used to authenticate or verify the identity of a user against a stored vocal signature, enroll a user onto a device or generate a vocal signature to supplement a training data set.

In this way, a balance is achieved between reliability of the generated vocal signature and the resource cost, such that the neural network model can be implemented to reliably generate a vocal signature on a device without excessively consuming resources such as battery power, memory and processor time. Performance is not sacrificed at the expense of reducing the resource cost. Overall, the vocal signature is improved, since it is at least as reliable as vocal signatures generated according to conventional methods, but can be generated at a reduced cost.

The method has uses in training the neural network, performing user enrolment, and performing speaker verification. The method can be implemented on devices not conventionally able to perform speaker verification, for example door locks, safes and Internet of Things devices. The resource cost of using the neural network is low enough that the implementation can be stored and used on device without needing to provide a conventional device with additional resources such as a larger battery, more memory or a more powerful processor. By implementing the method on a device, a vocal signature for a user can be generated on edge devices, without the need to access resources external to the device, or the need to transfer data from the device to another higher resource device such as a cloud device, and whilst maintaining accuracy. A lower resource costs typically requires accuracy in the final vocal signature to be sacrificed. This is undesirable in the context of speaker verification, as it poses a risk to the security of device features locked behind speaker verification. The present method offers the ability to generate a vocal signature as accurate as can be generated by prior methods, at a fraction of the resource cost. This is an especially advantageous benefit of the present method. Edge devices may be thought of as the devices at the endpoints of a network, where local networks interface with the internet.

By extracting the vocal signature from the fully-connected layer after the statistics pooling layer, the vocal signature exhibits better performance compared to if the vocal signature is extracted from another layer of the neural network.

Due to the relatively small number of layers, and by performing max pooling twice, as the input feature vector is processed by the layers of the neural network, the present method may be performed in a resource constrained environment such as a device like at the edge. A resource constrained environment is one where, for example, total available electrical power, memory, or processing power is limited. The present method uses less electrical power, less memory and less processing power in operation than typical methods of generating a vocal signature for a user. This is both because the neural network itself consumes fewer resources than a conventional neural network, and because the generated vocal signature has low dimensionality. At the same time, the usability of the vocal signature is consistent when compared to conventional methods.

As well as reducing the footprint of the model, by performing speaker recognition in this way the carbon footprint of performing speaker recognition is reduced. Specifically the carbon footprint is reduced since the number of calculations required to generate a vocal signature is reduced, which directly reduces the amount of electrical power required to generate a vocal signature.

The vocal signature determined by the neural network architecture of the first aspect may be a vector comprised of 128 dimensions. Each dimension represents a different feature, or characteristic of the user’s voice that does not change over the vocal sample. These are known as global characteristics.

Despite the lower dimensionality of the vocal signature, there is no loss of performance or reliability.

In an implementation speaker verification may be performed on a device. In this implementation the method may further comprise comparing the generated vocal signature with a stored vocal signature; and when the generated vocal signature and the stored vocal signature satisfy a predetermined similarity requirement, verifying that the stored vocal signature and the generated vocal signature are likely to originate from the same user.

As explained above, speaker verification is the process of ascertaining if a presented vocal signature is likely to originate from the same speaker as a stored vocal signature. The stored vocal signature is a reference vector that represents the voice of an authorized user, and is generated when a user enrolls onto a device. Speaker verification necessarily involves generating a vocal signature to compare with the stored vocal signature. By generating a vocal signature as described above and comparing it to a stored vocal signature, the present disclosure facilitates speaker verification in a resource constrained environment. The low dimensionality of the vocal signature is important, as this also means that comparing the stored and generated vocal signature is less resource intensive. There are less elements in the vocal signatures, so the number of calculations required to compare them is reduced. The above mentioned advantages of generating a vocal signature in a resource constrained environment are also advantages of performing speaker verification in the same environment.

The stored vocal signature is one that is generated at an earlier time, for example when the user enrolls themselves onto the device. User enrolment is the process of teaching the device who the authorized user is. The enrolment could be performed by generating one or more vocal signatures according to the first aspect, then these are averaged to account for background noise and variations in characteristics of the user’s voice. The averaged vocal signature is then stored, and used as a reference for the characteristics of the authorized user’s voice. Equally, the process of enrolment may be performed using a known method. The important point is that the authorized user has already created and stored a vocal signature on device. Vocal signatures generated at a later time are then compared to the stored vocal signature.

The step of comparing the generated vocal signature with the stored vocal signature may comprise calculating a similarity metric to characterize the similarity of the generated vocal signature and the stored vocal signature.

In an example, the similarity metric might be the cosine similarity of the generated vocal signature and the stored vocal signature, and the step of comparing comprises calculating the cosine similarity of the generated vocal signature and the stored vocal signature.

The cosine similarity metric is particularly advantageous for comparing vocal signatures, as the magnitude of the vocal signatures being compared does not affect the result. Cosine similarity measures the angle created between two vectors, regardless of their magnitude. The angle created between the stored and generated vocal signature can be interpreted as a measure of how similar the two vocal signatures are.

Alternatively or additionally, the similarity metric might be the Euclidean similarity metric, and the step of comparing the generated vocal signature with the stored vocal signature comprises calculating the Euclidean similarity of the generated vocal signature and the stored vocal signature.

By using a metric such as cosine similarity, Euclidean similarity or any other suitable similarity metric, robust comparison between the generated and stored vocal signatures may be performed. Using a combination of similarity metrics further improves confidence that the generated and stored vocal signatures are similar.

A second aspect of the invention provides a device. The device comprises a storage module, a processing module and a feature extraction module, the storage module having stored thereon instructions for causing the processing module to perform the steps of receiving, by the device, a vocal sample from a user; extracting, by the feature extraction module, a feature vector that describes characteristics of the user’s voice from the vocal sample; and processing, by the processing module, the feature vector using a trained neural network. The processing comprises: inputting elements of the feature vector to a first convolutional layer; operating on the inputted elements with the first convolutional layer; performing max pooling using a first max pooling layer; operating on the activations of the first max pooling layer using a second convolutional layer; performing max pooling using a second max pooling layer; inputting activations of the second max pooling layer to a statistics pooling layer; and inputting activations of the statistics pooling layer to a fully-connected layer; extracting the activations of the fully-connected layer; and generating a vocal signature for the user, wherein elements of the vocal signature are based on the extracted activations, wherein the vocal signature can be used to perform speaker verification.

The neural network model utilized by the invention is processor independent, and so can be implemented on any kind of processor, regardless of the processor’s architecture. This allows for the methods of the first and second aspects to be performed on conventional devices. There is no need to create resource rich devices for performing the methods of the first aspect. The method can therefore be performed on any kind of device provided it includes memory and a processor.

As mentioned, the neural network model used in the first aspect facilitates generating a robust vocal signature in a resource constrained device. An example of a resource constrained device is a device which is not connected to a cloud network. That is to say, it is a device that relies on computing resources, such as a processor located physically on the device. It is particularly advantageous for such a device to comprise an implementation of the neural network used by the first aspect as it creates the possibility of performing speaker verification without risking sensitive data of the user.

By generating a vocal signature on a device, without transmitting and data elsewhere the need to cool and maintain a server room is removed. This significantly reduces the carbon footprint generated by performing speaker recognition.

A third aspect of the invention provides a system for implementing a neural network model. The system comprises a cloud network device, wherein the cloud network device comprises a first feature extraction module, a first storage module, and a first processing module, the first storage module having stored thereon instructions for causing the first processing module to perform operations comprising: extracting, by the first feature extraction module, a feature vector that describes characteristics of a speaker’s voice from a vocal sample; and processing, by the first processing module, the feature vector using an untrained neural network. The processing comprises: inputting elements of the feature vector to a first convolutional layer; operating on the inputted elements with the first convolutional layer; performing max pooling using a first max pooling layer; operating on the activations of the first max pooling layer with a second convolutional layer; performing max pooling using a second max pooling layer; inputting activations of the second max pooling layer to a statistics pooling layer; inputting activations of the statistics pooling layer to a first fully-connected layer; inputting activations of the first fully-connected layer to a second fully-connected layer; applying a softmax function to activations of the second fully-connected layer; outputting, by the softmax function, a likelihood that the speaker is a particular speaker in a population of speakers. Then, based on the output, train the neural network model, thereby learning a value for each of the weights that connect nodes in adjacent layers of the neural network; send the learned weights to a device, the device comprising a second storage module, a second processing module, and a second feature extraction module, the second storage module having stored thereon instructions for causing the processing module to perform operations comprising receiving, by the device, a vocal sample from a user; extracting, by the second feature extraction module, a feature vector that describes characteristics of the user’s voice from the vocal sample; and processing, by the second processing module, the feature vector using a trained neural network, wherein the processing comprises: inputting elements of the feature vector to a first convolutional layer; operating on the input feature vector with the first convolutional layer; performing max pooling using a first max pooling layer; operating on the activations of the first max pooling layer with a second convolutional layer; performing max pooling using a second max pooling layer; inputting activations of the second max pooling layer to a statistics pooling layer; and inputting activations of the statistics pooling layer to a fully-connected layer; extracting the activations of the fully-connected layer; and generating a vocal signature for the user, wherein elements of the vocal signature are based on the extracted activations, wherein the vocal signature can be used to perform speaker verification according to claim 8, the device being configured to: receive learned weights sent by the cloud network device; store the learned weights in the second a storage module of the device; and initialize the implementation of the neural network model stored in the second storage module of the device based on the learned weights.

According to the system of the third aspect, the neural network model used by the method of the first aspect is implemented on a device by first training the neural network model on a cloud network device, where constraints such as power consumption, available memory, and available processing power are not a limiting factor. Training a neural network involves calculating a value for each of the weights that connect nodes in adjacent layers. The neural network model trained on the cloud network device is largely the same as the neural network model used on the device, however, during training, the neural network model further includes a second fully-connected layer and a softmax function. The second fully-connected layer and softmax function are only useful for training the neural network, and not useful at inference time, that is, when using the model to generate a vocal signature on the device. Accordingly, the neural network model on the device does not include a second fully-connected layer or a softmax function. Then, once these weights are calculated on the cloud network device, they are then sent to a device, such as the device of the third aspect, and the weights are used to initialize a neural network model on the device.

The device that receives the weights can then use the neural network model to perform user enrolment and inference. If the neural network had already been initialized, then the received weights could be used to update the neural network model. For example, this might be done as part of a continuous feedback process based on feedback from the user. The system of implementing the neural network model allows the neural network to function reliably in a resource constrained environment.

The step of sending may optionally comprise: saving the learned weights; and sending the file to the device.

The cloud network device may be a centralized server, or a device with access to sufficient computing resources to train the neural network.

A fourth aspect provides a computer readable storage medium comprising instructions which, when executed by a processor, cause the processor to perform the steps of receiving, by the device, a vocal sample from a user; extracting, by the feature extraction module, a feature vector that describes characteristics of the user’s voice from the vocal sample; and processing, by the processing module, the feature vector using a trained neural network. The processing comprises: inputting elements of the feature vector to a first convolutional layer; operating on the input feature vector with the first convolutional layer; performing max pooling using a first max pooling layer; operating on the activations of the first max pooling layer with a second convolutional layer; performing max pooling using a second max pooling layer; inputting activations of the second max pooling layer to a statistics pooling layer; and inputting activations of the statistics pooling layer to a fully-connected layer; extracting the activations of the fully-connected layer; and generating a vocal signature for the user, wherein elements of the vocal signature are based on the extracted activations, wherein the vocal signature can be used to perform speaker verification.

A further aspect provides a method for training a neural network model. The method comprises extracting, by the first feature extraction module, a feature vector that describes characteristics of a speaker’s voice from a vocal sample; and processing, by the first processing module, the feature vector using an untrained neural network, wherein the processing comprises: inputting elements of the feature vector to a first convolutional layer operating on the inputted elements with the first convolutional layer; performing max pooling using a first max pooling layer operating on the activations of the first max pooling layer with a second convolutional layer; performing max pooling using a second max pooling layer inputting activations of the second max pooling layer to a statistics pooling layer; a inputting activations of the statistics pooling layer to a first fully-connected layer; inputting activations of the first fully-connected layer to a second fully-connected layer applying a softmax function to activations of the second fully-connected layer outputting, by the softmax function, a likelihood that the speaker is a particular speaker in a population of speakers based on the output, train the neural network model, thereby learning a value for each of the weights that connect nodes in adjacent layers of the neural network.

### BRIEF DESCRIPTION OF THE DRAWINGS

The invention will now be described with reference to the figures, in which:

FIG. 1 is a flowchart illustrating a method of generating a vocal signature by using an implementation of a reduced profile neural network stored on a device according to the invention;

FIG. 2 is a schematic representation of a reduced profile neural network architecture for generating a vocal signature;

FIG. 3 is a flowchart illustrating a method of performing speaker verification on the device using the reduced profile neural network illustrated in FIG. 2 according to the invention;

FIG. 4 is a flowchart illustrating a method performed by a system for implementing a neural network to generate a vocal signature or perform speaker verification according to the invention;

FIG. 5 is a diagram of a system for performing speaker verification at the edge; and

FIG. 6 is a schematic diagram of the device according to the invention.

### DETAILED DESCRIPTION

Performing speaker recognition is usually a resource intensive process that requires significant amounts of processing power, electrical power and memory. This limits the environment in which speaker recognition can be performed to environments where sufficient resources are available. Typically, these resources are available in a cloud network, where a centralized network device with access to the resources needed performs speaker verification using biometric data sent from a user, for example a vocal sample. This approach is limited. One limitation is that the user’s biometric data is sent off device more frequently, which presents a risk that the user’s data will be intercepted by a malicious third-party. That is, not only is user data sent off device during user enrolment and when training the neural network model, but user data must also be sent off device at inference time. Inference occurs much more frequently than enrolment and training, so this poses the greatest risk. The underlying limitation is that current methods of speaker verification using neural networks are too resource intensive to practically implement on devices such as smartphones, tablets, and Internet of Things devices, where limitations such as finite battery power, processing power and memory must be accounted for. According to the present disclosure, speaker verification can be performed without reliance on a cloud network with a method that takes advantage of a suitable neural network.

In a proposed method according to the invention, a user provides a vocal sample, from which a feature vector that describes the characteristics of the user’s voice is extracted. The feature vector is used as input to a neural network with two convolutional layers, a statistics pooling layer and a fully-connected layer. Max pooling is performed after each convolutional layer. The activations of the fully-connected layer are extracted to generate a vocal signature for the user. The neural network model used in the method has a reduced profile compared to conventional models. By reduced, we mean that there are fewer layers, and fewer nodes per layer. The vocal signature generated by the neural network has fewer dimensions, and can be stored using less memory, than vocal signatures generated according to conventional methods.

Whereas previous solutions sought to take advantage of as many resources as possible, to make speaker verification as quick and reliable as possible, the approach taken by the present invention is different. Here, knowing that resources are limited, the approach is to use as few resources as possible. However, the specific arrangement of the neural network leads to equally reliable performance when compared to previous, resource intensive, solutions.

The generated vocal signature can then be compared to a stored vocal signature, and the identity of the user can be authenticated. The stored vocal signature is a reference signature for the user, and is generated, using the same neural network architecture, when a user performs biometric enrolment on the device.

The methods of generating a vocal signature and performing speaker verification are performed on a user’s device, without the need to send any data to a cloud network. The user’s data is therefore more secure, and the method can be performed on devices that traditionally could not perform speaker verification, including devices that are not or cannot be connected to the internet. The method therefore allows for speaker verification to be performed at the edge of a network. The “edge” of a network refers to endpoints of a network, where devices interface with the internet. For example, smartphones, tablets and laptops are some examples of devices operating at the edge. Despite the reduced profile of the neural network model, and the reduced dimensionality of the generated vocal signature, performance is not lost when the generated vocal signature is used, for example during enrolment or speaker verification. That is, reliability of the generated vocal signature is not sacrificed at the expense of reducing the resource cost, and speaker verification can now be performed at the edge.

By using the methods of generating a vocal signature and performing speaker verification described below, similar performance is achieved compared to methods for doing the same performed using cloud network resources at a reduced resource cost.

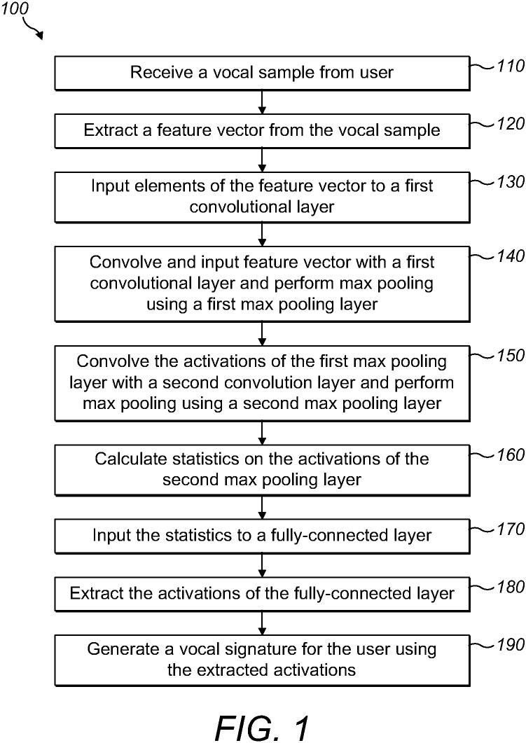

One implementation of a method of generating a vocal signature performed by a device is illustrated by flowchart 100 in FIG. 1.

First, at step 110, a vocal sample is received from the user. The vocal sample is received by a microphone in the user’s device, and may be received after prompting the user to provide a voice sample. For example, the user may attempt to access a password protected function of the device, in response to which, the user is prompted to provide a vocal sample in place of a password. The vocal sample may be temporarily stored as a file in a suitable format, for example as a .wav file.

The vocal sample could be a particular phrase spoken by the user. It might be a phrase that only the user knows. Alternatively, the vocal sample could comprise any phrase spoken by the user.

Next at step 120, a feature vector is extracted from the vocal sample. A feature vector is an n-dimensional vectorial representation of the vocal sample. The feature vector is typically determined by calculating the mel-frequency cepstral coefficients (MFCCs) of the vocal sample. For example, a number of between 20 to 80 MFCCs could be calculated for the vocal sample. We emphasize that this is an example only, and other numbers of MFCCs could be calculated. Methods of calculating MFCCs of a vocal sample are known in the art, and would be understood by the skilled person. The options for feature extraction are well known in the field, and improvements are regularly sought. What is important is that the feature extraction stage generates a representation of the vocal sample for input to the input layer of the neural network, with the aspects of the speech sample being represented by discrete values.

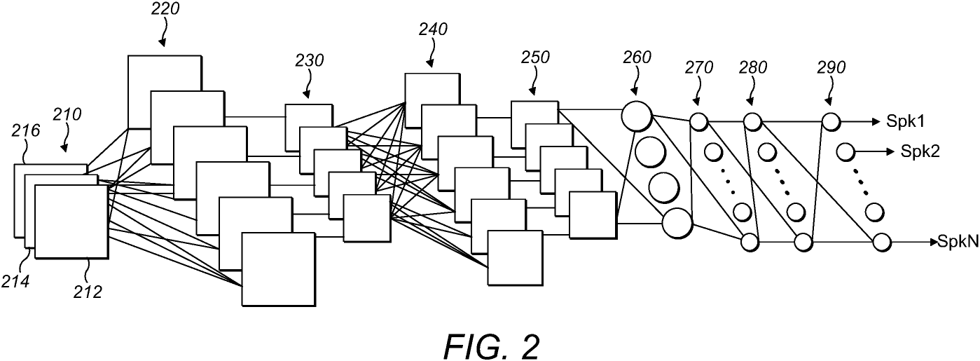

The feature vector is then processed using a neural network model implemented on the device. The processing steps are shown by steps 130 to 170 of FIG. 1, but before discussing these in detail, it is useful to provide details of the trained neural network model stored on the device. The neural network model is shown in FIG. 2.

FIG. 2 illustrates a neural network with a representation of an input feature vector 210, first convolutional layer 220 and second convolutional layer 240. After each convolutional layer, there is a max pooling layer. Specifically, after the first convolutional layer 220 there is a first max pooling layer 230, and after the second convolutional layer, there is a second max pooling layer 250. After the second max pooling layer 250, there is a statistics pooling layer 260, which is connected to a first fully-connected layer 270. A second fully-connected layer 280 is provided after the first fully-connected layer 270. Finally a softmax function 290 is applied to the output of the second fully-connected layer.

As mentioned, the input feature vector 210 is a sequence of MFCCs or other acoustic features extracted from the received vocal sample. The input feature vector 210 could be formed of one or more vocal samples. For example, 3 vocal samples, corresponding to boxes 212, 214 and 216 could form the input feature vector 210. The vocal sample is a two-dimensional vector, with one dimension being the number of MFCCs extracted from each vocal sample, and the other dimension being the duration of each vocal sample. The size of each input vocal therefore varies according to the exact duration of the vocal sample.

The outputs of the softmax function are denoted by discrete labels Spk1, Spk2 and SpkN. In other words, the softmax function has N outputs, with each being a discrete category. In the present context, each category corresponds to a different speaker in a population of speakers. The population of speakers may be the speakers present in the data set used to train the neural network model. The output of the softmax function gives an indication of the confidence that a given speech sample belongs to a given speaker in a population of speakers.

Conceptually, the neural network model can be thought of as two modules, though these are not separate modules in practice. The two convolutional layers form a module for processing frame level features. This means that the convolutional layers operate on frames of the input vocal sample, with a small temporal context, centered on a particular frame.

The second module is formed of the statistics pooling layer, both fully-connected layers and the softmax function. The statistics pooling layer calculates the average and standard deviation of all frame level outputs from the second max pooling layer, and these are concatenated to form a vector of 3000 × 1 dimensions. This allows for information to be represented across the time dimension, so that the first fully-connected layer and later layers operate on the entire segment.

In some examples, a software library may be used to perform the concatenation. The concatenation may be performed by concatenating two 1500 × 1 vectors to produce a 3000 × 1 vector.

An example topology of the neural network, including the temporal context used by each layer is provided in Table 1. In Table 1, t is a current frame being processed by the neural network model, T is the total number of frames in the input vocal sample, and N is the total number of speakers in a data set used to train the neural network model. The first max pooling layer uses three temporal contexts, which, in this example, are t - 2, t, t + 2. This results in the input dimension of the first max pooling layer being 3 times larger than the output dimension of the first convolutional layer. This is achieved by concatenating the three context windows together. It is emphasized that the topology shown in Table 1 is merely an example, and other topologies are possible.

TABLE 1

An example of a specific neural network topology

| Layer | Layer Context | Total Context | Input × Output |
|---|---|---|---|
| First Convolutional Layer | [t - 2, t + 2] | 5 | 120 × 256 |
| First Max Pooling Layer | {t - 2, t, t + 2} | 9 | 768 × 256 |
| Second Convolutional Layer | {t} | 9 | 256 × 256 |
| Second Max Pooling Layer | {t} | 9 | 256 × 1500 |
| Statistics Pooling Layer | [0, T) | T | 1500T × 3000 |
| First fully-connected Layer | {0} | T | 3000 × 128 |
| Second fully-connected Layer | {0} | T | 128 × 128 |
| Softmax function | {0} | T | 128 × N |

While the individual functions of each layer are known, the specific arrangement and combination of layers used here is particularly advantageous.

The arrangement of the layers as shown in FIG. 2 is particularly beneficial for realizing speaker verification at the edge. By performing two convolutions, and performing max pooling after each convolution, the vocal data is downsampled without leading to a loss of performance. By downsampling the data effectively, as is done here, a balance is struck between having enough data that can be processed at the later layers of the neural network to perform robust speaker verification, and reducing resource usage on device. If downsampling is not performed at an initial stage of the processing, then the number of calculations required by the processor of the device increases considerably, leading to excessive resource cost. At the same time, if the data is compressed too much, then the reliability and performance of the generated vocal signature is decreased. In some cases, depending on the level of reliability required for a particular use-case, it could cause the generated vocal signature to be unusable. By performing the downsampling as described, the competing needs for performing reliable vocal signature verification without excessive consumption of on-device resources, are balanced.

Another advantage of the model is that the amount of temporal context required by the model is reduced compared to conventional approaches. This is due to using only two convolutional layers. By using the appropriate amount of context, additional types of MFCCs are not required as part of the input feature vector. This cuts down feature processing, and accordingly speeds up the process of generating a vocal signature.

It is worth noting that the second fully-connected layer 280 and the softmax function 290 are not needed during the method of generating a vocal signature of the user. Rather, as will be discussed below in relation to step 180, the first fully-connected layer 270 is the last layer that is needed to generate a vocal signature. The second fully-connected layer 280 and softmax function 290 are typically only used when training the neural network. This is discussed below in relation to FIG. 4.

It is to be understood that the nodes of each layer are connected to the adjacent layers by channels, which we also refer to as weights. In FIG. 2, the channels are represented by lines connecting between the nodes. It must be emphasized that the channels shown are merely illustrative, and the nodes may be connected in other ways.

The nodes of the neural network perform a weighted sum of the values provided as inputs, and may additionally add a bias, in the form of a scalar value, to the result of the weighted sum. The total result from each node is then passed to an activation function, which in turn determines if the result from a particular node is propagated to the connected nodes in the next layer. Nodes which pass data to the next hidden layer are known as activated nodes.

The activation function is a rectified linear unit (ReLU). If the weighted sum of a node is greater than a threshold value, then the ReLU passes the weighted sum to any connected nodes in the next layer. If the weighted sum is lower than a threshold value, then the output of the ReLU is zero, and the node is not activated. Using a ReLU improves stability of the neural network model.

Specifically, stability is improved in that the ReLU prevents gradients in a network, which are a part of the training process, from becoming too small during training of the neural network. If gradients become too small, they can be said to have vanished, and the node will never produce an output. Another advantage of ReLU is that is more computationally efficient than other activation functions, such as a sigmoid activation function.

At the time of generating a vocal signature, the neural network on the device is already trained. By this we mean that the value of the weights connecting the nodes of the neural network have been learned. The neural network of the device is trained according to a method discussed further below in relation to FIG. 4.

Returning to FIG. 1, at step 130 the first convolutional layer 220 receives the elements of the feature vector 210 as input. Each node of the convolutional layer receives one element of the feature vector. Therefore the convolutional layer has as many nodes as the feature vector has elements. The first convolutional layer 220 operates on the elements of the input feature vector with a kernel at step 140. The kernel acts as a filter that picks out specific features of the feature vector. As part of step 140, the convolved feature vector is then used as input to the first max pooling layer 230. The first max pooling layer downsamples the convolved feature vector using a filter. The filter is usually implemented as a square matrix which is superimposed onto the convolved feature vector. For example, a 2 × 2 or 3 × 3 square matrix may be used, but other dimensions may be used. By sweeping the filter across the convolved feature vector using a step, the convolved feature vector is downsampled. For example, a step value of 1 or 2 may be used. Other step values are of course possible. By varying the dimensions of the filter and the size of the step, the amount of downsampling can be tuned to vary the performance of the neural network as needed in a particular use-case. For example, the amount of compression could be tuned to generate the vocal signature faster, at the cost of some reliability, or vice versa.

After the first round of max pooling, the activations of the first max pooling layer represent a feature vector that has been passed through one convolutional layer, and downsampled. The activations of the first max pooling layer are then operated on with the second convolutional layer at step 150. The second convolutional layer 240 typically operates on the input that it receives in the same way as the first convolutional layer 220. Alternatively, the second convolutional layer 240 may use a different kernel, which picks out something different about the data. As part of step 150, max pooling is performed for a second time, by a second max pooling layer. The filter and step used in the second max pooling layer is typically the same as the filter used by the first max pooling layer 230. Alternatively, in some cases the dimensions of the filter and step may be different to those used in the first max pooling layer 230.

As has been discussed, processing the input feature vector in this way, that is, by passing the input twice through two convolutional layers, and performing max pooling each time provides the advantage that the data has been compressed, but the essential features of the feature vector have not been lost. This allows a device with limited processing and electrical resources to perform the processing without excessively consuming on device resources.

Other methods of compressing the input data are limited. For example, another approach is to arrange a plurality of feed-forward layers which can slowly whittle down the data. However, a large number of layers would be required to achieve the same amount of compression which here is achieved by two convolutional layers. The approach using feed-forward layers is further limited in that the data propagated through the layers is dependent only on the arrangement of the layers themselves. On the other hand, the choice of kernel associated with each convolution layer allows for data to be intelligently selected. Different qualities of the data can be extracted by using different kernels, and this cannot be achieved using a plurality of feed-forward layers.

Once the second round of max pooling is complete, the input feature vector has been passed through two convolutional layers and downsampled twice. At this stage, the activations of the second max pooling layer are used as input to a statistics pooling layer 260. The function of a statistics pooling layer is known. At step 160, the statistics pooling layer calculates statistics of the activations received from the second max pooling layer. In particular, the statistics pooling layer calculates first order and second order statistics of the input. Typically, this means that the mean and standard deviation of the input to the statistic pooling layer is calculated. The mean and standard deviation are concatenated together and, at step 170, are provided as input to the first fully-connected layer 270.

At step 180, the activations of the first fully-connected layer 270 are extracted. The first fully-connected layer 270 may also simply be referred to as the fully-connected layer, which represents the vocal signature of the user. In some implementations, the first fully-connected layer 270 may comprise 128 nodes. Each node corresponds to one dimension of the user’s vocal signature. This is noteworthy, as producing a functioning vocal signature with just 128 dimensions has not been achieved before. It is to be understood that the vocal signature is an m-dimensional vector quantity. The vocal signature can therefore be easily handled by on device processors and stored in device memory without hogging device resources. This is possible due to the use of two convolutional layers, each followed by a max pooling layer, which allows the input feature vector to be compressed without loss of key characteristics of the user’s voice.

By extracting the user’s vocal signature from the first fully-connected layer, as opposed to a subsequent fully-connected layer, the processing data has only been transformed once since the statistics have been calculated. The data extracted from the first fully-connected layer is therefore more meaningful for representing global, i.e. unchanging, characteristics of the user’s voice.

Finally, at step 190, a vocal signature for the user is generated based on the extracted activations of the fully-connected layer. The vocal signature can be stored locally on the device, at least temporarily, and can be used to perform speaker verification, as will be described below.

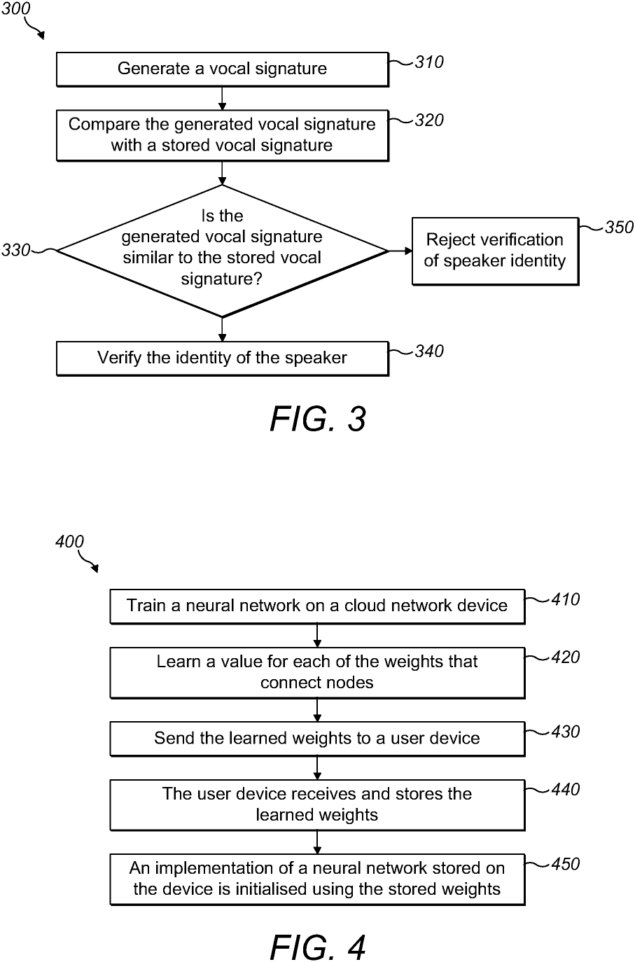

FIG. 3 illustrates a method 300 of performing speaker verification. At step 310, a vocal signature is generated. The signature is generated using the method described above in FIG. 1. That is to say, the vocal signature is generated on device, without any need to communicate with external computing resources such as a cloud network.

The process of speaker verification can be text-dependent or text-independent. A text-dependent process requires the received vocal sample to be a particular phrase spoken by the user. It might be a phrase that only the user knows. Alternatively, in a text-independent scenario, the vocal sample could comprise any phrase spoken by the user. The method of generating a vocal signature discussed above is capable of implementing both. If a text-dependent processing is desired, this may involve adding a speech recognition component to the neural network model. For example, this may be implemented with a separate classifier.

At step 320, the generated vocal signature is compared to a vocal signature stored on the device. The vocal signature stored on the device will also be an m-dimensional vector quantity, and is usually creating during a process of enrolling the user.

Different methods of comparing the stored and generated vocal signatures are possible. In one implementation, the comparison is performed by calculating the cosine similarity of the generated vocal signature and stored vocal signature. Cosine similarity is calculated according to Equation 1, where A · B is the dot product of two vectors A and B, |A| is the magnitude of A, |B| is the magnitude of B, and cos θ is the cosine of the angle, θ, between A and B.

$$cos θ = \frac{A ⋅ B}{\left|A\right| \left|B\right|}$$

The value of cos θ ranges between -1 and +1, with a value of -1 indicating that the two vectors are oriented in opposite directions to each other and a value of +1 indicating that two vectors are aligned. Therefore, depending on the use-case, the sensitivity of the comparison may be adjusted to allow certain values, e.g. relatively higher or lower values of cos θ to indicate that the generated vocal signature is presented by the same individual that the stored vocal signature originated from.

In another implementation, since the stored and generated vocal signatures are both m-dimensional vectors, another way to compare their similarity is to calculate the distance between them. This can be done by calculating the Euclidean distance between the stored vocal signature and the generated vocal signature. This may be done using the Euclidean metric in n-dimensions:

$$d \left(a , b\right) = \sqrt{{\left({a}_{1} - {b}_{1}\right)}^{2} + {\left({a}_{2} - {b}_{2}\right)}^{2} + ⋯ + {\left({a}_{n} - {b}_{n}\right)}^{2}}$$

Taking the generated vocal signature as vector a and the stored vocal signature as vector b, equation (2) gives a similarity measure the two which can be used to infer whether the individual who presented the generated vocal signature is the same as the individual that the stored vocal signature originated from.

Although two specific similarity measures have been described, it is to be understood that any similarity metric can be used. Two or more similarity metrics could also be used in combination to increase confidence in the result. For example, the cosine similarity of the stored and generated vocal signatures can be calculated, and then the Euclidean similarity can be calculated. On finding agreement between the two similarity metrics, confidence that both metrics have given the correct result is increased. Disagreement between two or more metrics may indicate that further information is needed to verify the user, such as generating another voice sample, or providing a PIN.

At step 330, based on the result of the comparison, the identity of the speaker is either verified or rejected. Specifically, at step 340, if the result of the comparison shows that the generated vocal signature has a suitably high degree of similarity to the stored vocal signature, then the identity of the user is verified. By this we mean that the presenting user is confirmed to be the same as the user who generated the stored vocal signature. When this is the case, then the user may proceed with using the function of the device that prompted verification to be required.

On the other hand, if the results of the comparison indicate that the generated vocal signature is not similar to the stored vocal signature, then verification is rejected at step 350. The user may be allowed another attempt at authentication. After repeat failed attempts they may be barred from the device, or prompted to try another form of verification, like a PIN.

The ability to perform speaker verification at the edge opens up a number of new possibilities. For example, speaker verification can be implemented as a layer of security for a door or a safe. An electronic locking system, such as those found on a door or safe, would not typically be able to access the cloud, or include any other access to the resources needed to perform speaker verification, and so would not usually have the option of performing speaker verification. Now, by implementing a method of speaker verification that uses a reduced profile neural network that can be implemented entirely on a device, without requiring any external resources, this has become possible. This would allow a user to unlock and lock a door or safe with just their voice. Depending on if the process is chosen to be text-dependent or text independent, the user may have to speak a particular phrase. This has clear advantages in terms of increasing the security of electronic lock systems, and is widely applicable to anything with an electronic lock, or could be retrofitted with an electronic lock.

Staying with the example of a safe capable of performing speaker verification, first, the neural network implantation to be used on the safe must be trained. This can be done as described below in relation to FIG. 4. Training would be done before the user purchases the safe, so that the safe is ready to use. Then, the user would enroll their voice onto the safe. That is, the safe would learn the characteristics of the user’s voice. This would also make use of the method of generating a vocal signature discussed in relation to FIG. 1. Specifically, the user would be prompted, by the safe, to speak. This may be done a number of times, and then an average feature vector calculated based on the number of vocal samples, to ensure the user’s voice is well represented. Then, a vocal signature is generated, and this is stored on the safe. Importantly, the entire process is performed on device, without ever needing to send the user’s data off device. It is to be appreciated that this is particularly important for a safe; it is a security risk to send data that could be used to open the safe to the cloud. Now that the user is enrolled, whenever they wish to open the safe, they may do so with only their voice. To do this, the safe would implement the method of speaker verification. All of this is done in device, and is achieved due to the specific way in which the vocal data is compressed by the neural network.

This could be implemented by including a dedicated system on chip (SoC) as part of a chipset. For example, a system on chip may comprise a digital signal processor and a dedicated neural network processor. An SoC may contain a dedicated memory storage module that stores the neural network weights. It may contain a dedicated memory unit that can communicate with the dedicated storage. It may contain a dedicated processing unit optimised for generating a vocal signature using the neural network model.

In addition to the dedicated components, the SoC may contain a separate processor and separate storage. The separate storage can be used for the similarity calculation, and to store the enrolment vocal signature that is used for comparison when calculating the similarity between a generated vocal signature and a stored vocal signature.

The dedicated neural network processor would be configured with the neural network architecture described in this disclosure. The SoC could be produced as part of a standard chipset which could be included on edge devices as needed. The neural network model could be implemented using a chip specific programming language, and the language used to implement the model on the chip may be different to the language used to implement the model on the cloud during training. However, it is to be emphasized that the same weights that are learnt from training the model on the cloud are used to drive the neural network model on the chip.

Training would be performed before the SoC is installed in the device. This creates a more user-friendly experience, in that once the user has purchased the device, all they need to do is enroll themselves onto the device before it is ready to use. Alternatively, training could be performed when the user first turns the device on, to ensure that the model used on the device is up to date.

The methods described above take advantage of a trained neural network model implemented on device to generate a vocal signature and perform speaker verification. For this to be possible, the neural network must first be trained.

With reference to the steps 400 shown in FIG. 4, below we discuss a system for training a neural network according to the invention. The system comprises a cloud network device and a device. As shown by step 410, the network device is configured to train a neural network, such as the neural network shown in FIG. 2. Methods of training a neural network are known. For example, the neural network may be trained by backpropagation. Other methods could be used, as long as the value of weights connecting the nodes of the neural network are learned, as shown by step 420. Referring to FIG. 2, the second connected layer 280 and the softmax function 290 may be used during training the neural network. However, the weights related to these layers are not useful for generating a vocal signature. They are therefore discarded once training is complete. At step 440, the weights are then sent to the device that performs the methods of generating a vocal signature and performing speaker verification.

An example of how the neural network model may be trained through backpropagation is now described. A vocal sample of 2 to 4 seconds of speech, which corresponds to 200 to 400 frames is obtained. The vocal sample may belong to a speaker in a training data set of speakers, or it may be provided by a user. Feature extraction is performed as described previously, and a feature vector is extracted from the vocal sample. The feature vector is then processing by the neural network. Importantly, during training, a second fully-connected layer and a softmax function are used. The neural network model trains on 2 to 4 second speech samples at a given time, commonly referred to as an iteration or step. Once all of the training data has been passed through the network once, then an epoch has been completed. The process of passing training data through the network is repeated until the network is trained. The network is trained when the accuracy and error are at acceptable levels and not degrading. This can be tuned according to a desired level of accuracy. The accuracy and error is determined by examining the output of the softmax function. Specifically, the softmax function predicts the probability that the speaker who produced the vocal sample is a particular speaker in the training data set. If the prediction is correct, then it can be said that the model is trained. If the network is trained, then the softmax function can accurately classify the N speakers. The method to train the network is called stochastic gradient descent (SGD). The SGD updates network parameters for every training example.

Backpropagation is an efficient method for computing gradients. The gradients represent changes in the weights. The term backpropagation is used because conceptually, the process starts at the softmax function, and computes gradients from there, through each layer, back to the input layer. Backpropagation finds the derivative of the error for every parameter, therefore it computes the gradients.

SGD uses the gradients to compute the change in weights at each layer, again starting at the last layer and moving toward the input layer of the network. SGD is an optimisation, based on the analysis of the gradients that are being backpropagated. The SGD minimizes a loss function, where the loss function is cross-entropy, calculated from how well the softmax function made classified the N speakers.

In some implementations, sending the weights to the device may comprise saving the learned weights, for example by encoding them to a file and sending the file to the device. The weights, or the file, may be sent over a data connection such as an internet connection. Alternatively, the stored weights may be saved to a flash drive and uploaded to the device via a USB connection, or other physical connection.

Once the device receives the learned weights, they are stored, as shown by step 450, and then the device initializes the neural network on the device with the learned weights at step 450. To be clear, the neural network trained on the cloud network device has the same architecture as the neural network implemented on the device, and initially the neural network implemented on the device is not trained. By using the learned weights to initialize the untrained neural network, the neural network on the device is trained. After being trained, the neural network of the device is able to perform the methods of generating a vocal signature and speaker verification discussed above.

Training a neural network requires considerable computational, time and power resources. Therefore, by training the neural network in the cloud network device, the training is performed without any practical restriction on the time, or computational and power resources available. The weights are therefore learned with a high degree of precision and accuracy, which could not feasibly be achieved if the training was performed on the device.

It is emphasized that only training the neural network on the cloud network device is not enough to implement on device speaker verification. Having a neural network model with a reduced profile, and that compresses the data as described, by performing two convolutions, and then max pooling after each convolution is also necessary. The neural network model is required to ensure that the method can be performed without using an excessive amount of memory, on the device. Specifically, the entirety of the neural network model and the instructions for performing inference are embodied within a footprint of between 0 and 512 kilobytes in size. On top of that, the resulting vocal signature can be stored in a relatively small amount of memory, for example 1 kilobyte, and can be generated quickly, without consuming a large amount of electrical power. This is a direct result of the specific neural network architecture used to generate the vocal signature.

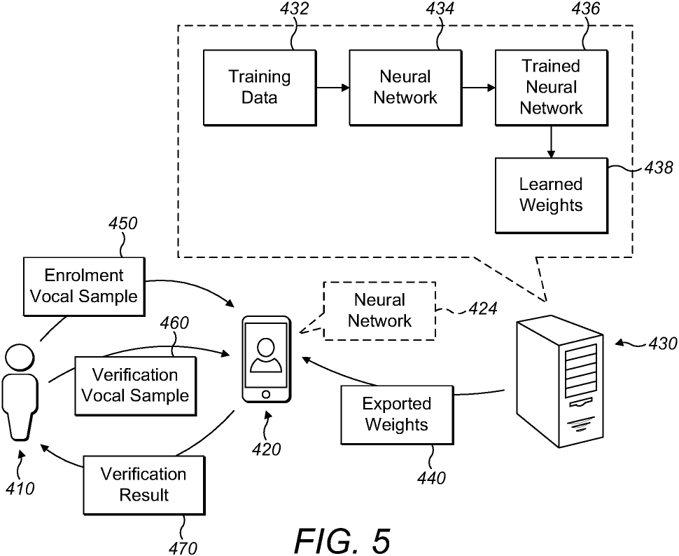

Various implementations of the present disclosure have been described above in terms of the methods performed to generate a vocal signature on device and subsequently use it to perform speaker verification. Now, looking to FIG. 5, an end-to-end of the user journey is described.

FIG. 5 shows an end user 410, an edge device 420, and a cloud network device 430. Although the device 420 is depicted as a smartphone, it will be appreciated that this could be any kind of edge device such as a door lock, a safe, or another electronic device.

The cloud network device 430 stores a neural network model 434, and the device 420 stores a neural network model 424. The neural network model 434 and the neural network model 424 are the same, except that the neural network model 434 on the cloud device includes a second fully-connected layer after the first fully-connected layer and a softmax function applied to the output of the second fully-connected layer. The neural network 434 on the cloud device is trained using training data 432. An exemplary method of training a neural network is by using backpropagation, and this is discussed further below. Once trained, the learned weights 438 are extracted from the trained neural network 436. The weights corresponding to the second fully-connected layer, and the softmax function are discarded at this stage.

The remaining weights 440 are then exported to the device 420. In addition to the weight, a decision threshold may also be exported to the device 420. A decision threshold determines how similar two vocal signatures should be for a speaker’s identity to be verified. This can also be updated as and when needed, according to the needs of the user. The exported weights are imported to an SoC on the device 420. The weights could be imported before the SoC is installed in the device 420. The neural network model on the SoC, which is untrained until this point, is then initialized using the exported weights 440. The exported weights 440 may be stored on device, in a storage medium, and accessed by the SoC to implement the neural network model. At this stage the device is ready for the user 410 to be enrolled.

The user 410 is enrolled by providing an enrolment vocal sample 450. The neural network model on the device 420 processes this, and produces a reference vocal signature for the user 410, which is stored on the device 420.

Now, at a later time, when the user wishes to verify their identity, for example to access certain functions, or unlock, the device, the user 410 provides a verification vocal sample 460. The neural network model 424 processes this, and a distance metric is used to calculate the likelihood that the verification vocal sample 460 and the enrolment vocal sample 450 originate from the same user.

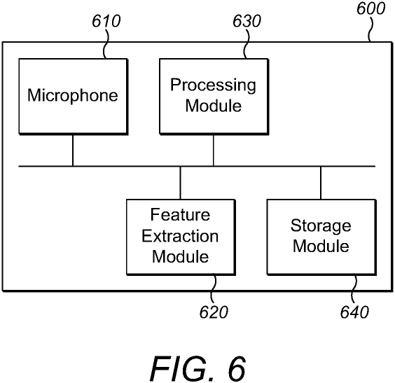

An example device on which a neural network used by implementations of the present disclosure is illustrated by FIG. 6. The device 600 includes a microphone 610, a feature extraction module 620, a processing module 630 and a storage module 640. The various components are interconnected via a bus or buses. The device of course includes other components like a battery, a user interface and an antenna, but these are not shown. The device is also be connectable to a cloud network device via wireless or wired connection. The storage module stores information, and can be implemented as volatile or non-volatile storage.

The processing module may be implemented as a system on chip (SoC) comprising a digital signal processor and a neural network processor. The neural network processor is configured to implement the neural network model illustrated in FIG. 2. Other examples of special purpose logic circuitry that could be used to implement the processing module is a field programmable gate array (FPGA) or an application specific integrated circuit (ASIC).

The methods described above are processor independent. This means that the methods may be performed on any chip that contains an on-board memory unit which can store the values of the weights of the trained neural network model as well as a single value that is the decision threshold for the similarity calculation.

The processor on the chip can be low-resource but needs enough memory to contain all or part of the learned neural network weights in memory to generate the vocal signature, as well as the instructions for performing speaker verification. It is possible to create the vocal signature in a manner where one layer at a time is loaded into memory, passing the output of one layer as input to the next layer. This would take more time to generate a vocal signature, but would allow for significantly less memory requirements. This is possible because once the neural network model is trained, it is only ever used to make a forward inference pass, and there is never any need to update weights or do backpropagation. The chip ideally has a microphone, but this is not essential. The chip ideally has a component that can extract features, for example MFCCs from the microphone input. This component can be embedded into the chip as an input processing unit, and is considered to be a separate unit from the processor and storage units.

The methods and processes described above can be implemented as code (e.g., software code). The cloud network device, or other devices discussed above may be implemented in hardware or software as is well-known in the art. For example, hardware acceleration using a specifically designed Field Programmable Gate Array (FPGA) may provide certain efficiencies.

For completeness, such code can be stored on one or more computer-readable media, which may include any device or medium that can store code and/or data for use by a computer system. When a computer system reads and executes the code stored on a computer-readable medium, the computer system performs the methods and processes embodied as code stored within the computer-readable storage medium. In certain embodiments, one or more of the steps of the methods and processes described herein can be performed by a processor (e.g., a processor of a computer system or data storage system).

1. A method of generating a vocal signature of a user performed by a device, the device comprising a feature extraction module, a storage module, and a processing module, the method comprising:
receiving, by the device, a vocal sample from a user;
extracting, by the feature extraction module, a feature vector that describes characteristics of the user’s voice from the vocal sample; and
processing, by the processing module, the feature vector using a trained neural network, wherein the processing comprises:
inputting elements of the feature vector to a first convolutional layer;
operating on the inputted elements with the first convolutional layer;
performing max pooling using a first max pooling layer;
operating on the activations of the first max pooling layer with a second convolutional layer;
performing max pooling using a second max pooling layer;
inputting activations of the second max pooling layer to a statistics pooling layer; and
inputting activations of the statistics pooling layer to a fully-connected layer;
extracting the activations of the fully-connected layer; and
generating a vocal signature for the user, wherein elements of the vocal signature are based on the extracted activations, wherein the vocal signature can be used to perform speaker verification.

2. The method of claim 1, wherein the vocal signature comprises 128 dimensions.

3. The method of claim 1, further comprising:
comparing the generated vocal signature with a stored vocal signature; and
when the generated vocal signature and the stored vocal signature satisfy a predetermined similarity requirement, verifying that the stored vocal signature and the generated vocal signature are likely to originate from the same user.

4. The method of claim 1, further comprising storing, by the storage module, the generated vocal signature, such that the stored vocal signature is a reference vocal signature for the user.

5. The method of claim 3, wherein comparing the generated vocal signature with the stored vocal signature comprised calculating a similarity metric to characterize the similarity of the generated vocal signature and the stored vocal signature.

6. The method of claim 4, wherein the similarity metric is a cosine similarity metric.

7. The method of claim 4, wherein the similarity metric is a Euclidean similarity metric.

8. A device comprising a storage module, a processing module, and a feature extraction module, the storage module having stored thereon instructions for causing the processing module to perform operations comprising:
receiving, by the device, a vocal sample from a user;
extracting, by the feature extraction module, a feature vector that describes characteristics of the user’s voice from the vocal sample; and
processing, by the processing module, the feature vector using a trained neural network, wherein the processing comprises:
inputting elements of the feature vector to a first convolutional layer;
operating on the inputted elements with the first convolutional layer;
performing max pooling using a first max pooling layer;
operating on the activations of the first max pooling layer with a second convolutional layer;
performing max pooling using a second max pooling layer;
inputting activations of the second max pooling layer to a statistics pooling layer; and
inputting activations of the statistics pooling layer to a fully-connected layer;
extracting the activations of the fully-connected layer; and
generating a vocal signature for the user, wherein elements of the vocal signature are based on the extracted activations, wherein the vocal signature can be used to perform speaker verification.

9. The device of claim 8 wherein the vocal signature comprises 128 dimensions.

10. The device of claim 8, further configured to:
compare the generated vocal signature with a stored vocal signature; and
when the generated vocal signature and the stored vocal signature satisfy a predetermined similarity requirement, verify that the stored vocal signature and the generated vocal signature are likely to originate from the same user.

11. The device of claim 8, further configured to store, by the storage module, the generated vocal signature, such that the stored vocal signature is a reference signature for the user.

12. The device of claim 10, further configured to compare the generated vocal signature with the stored vocal signature comprised calculating a similarity metric to characterize the similarity of the generated vocal signature and the stored vocal signature.

13. The device of claim 12, wherein the similarity metric is a cosine similarity metric.

14. The device of claim 12, wherein the similarity metric is a Euclidean similarity metric.

15. A system for implementing a neural network model comprising:
a cloud network device, wherein the cloud network device comprises a first feature extraction module, a first storage module, and a first processing module, the first storage module having stored thereon instructions for causing the first processing module to perform operations comprising:
extracting, by the first feature extraction module, a feature vector that describes characteristics of a speaker’s voice from a vocal sample; and
processing, by the first processing module, the feature vector using an untrained neural network, wherein the processing comprises:
inputting elements of the feature vector to a first convolutional layer;
operating on the inputted elements with the first convolutional layer;
performing max pooling using a first max pooling layer;
operating on the activations of the first max pooling layer with a second convolutional layer;
performing max pooling using a second max pooling layer;
inputting activations of the second max pooling layer to a statistics pooling layer; and
inputting activations of the statistics pooling layer to a first fully-connected layer;
inputting activations of the first fully-connected layer to a second fully-connected layer;
applying a softmax function to activations of the second fully-connected layer;
outputting, by the softmax function, a likelihood that the speaker is a particular speaker in a population of speakers;
based on the output, train the neural network model, thereby learning a value for each of the weights that connect nodes in adjacent layers of the neural network;
send the learned weights to a device, the device comprising a second storage module, a second processing module, and a second feature extraction module, the second storage module having stored thereon instructions for causing the processing module to perform operations comprising:
receiving, by the device, a vocal sample from a user;
extracting, by the second feature extraction module, a feature vector that describes characteristics of the user’s voice from the vocal sample; and
processing, by the second processing module, the feature vector using a trained neural network, wherein the processing comprises:
inputting elements of the feature vector to a first convolutional layer;
operating on the inputted elements with the first convolutional layer;
performing max pooling using a first max pooling layer;
operating on the activations of the first max pooling layer with a second convolutional layer;
performing max pooling using a second max pooling layer;
inputting activations of the second max pooling layer to a statistics pooling layer;
inputting activations of the statistics pooling layer to a fully-connected layer;
extracting the activations of the fully-connected layer; and
generating a vocal signature for the user, wherein elements of the vocal signature are based on the extracted activations, wherein the vocal signature can be used to perform speaker verification, the device being configured to:
receive learned weights sent by the cloud network device;
store the learned weights in the second storage module; and
initialize the implementation of the neural network model stored in the second storage module of the device based on the learned weights.

16. The system of claim 15, wherein the sending comprises:
saving the learned weights; and
sending the learned weights to the device.

17. A computer readable storage medium comprising instructions which, when executed by a processor cause the processor to perform a method comprising:
receiving, by the device, a vocal sample from a user;
extracting, by the feature extraction module, a feature vector that describes characteristics of the user’s voice from the vocal sample; and
processing, by the processing module, the feature vector using a trained neural network, wherein the processing comprises:
inputting elements of the feature vector to a first convolutional layer;
operating on the inputted elements with the first convolutional layer;
performing max pooling using a first max pooling layer;
operating on the activations of the first max pooling layer with a second convolutional layer;
performing max pooling using a second max pooling layer;
inputting activations of the second max pooling layer to a statistics pooling layer; and
inputting activations of the statistics pooling layer to a fully-connected layer;
extracting the activations of the fully-connected layer; and
generating a vocal signature for the user, wherein elements of the vocal signature are based on the extracted activations, wherein the vocal signature can be used to perform speaker verification.

18. The computer readable storage medium of claim 18, wherein the vocal signature comprises 128 dimensions.

19. The computer readable storage medium of claim 18, wherein the instruction further comprise:
comparing the generated vocal signature with a stored vocal signature;
when the generated vocal signature and the stored vocal signature satisfy a predetermined similarity requirement, verifying that the stored vocal signature and the generated vocal signature are likely to originate from the same user;
wherein comparing the generated vocal signature with the stored vocal signature comprised calculating a similarity metric to characterize the similarity of the generated vocal signature and the stored vocal signature, wherein the similarity metric is a cosine similarity metric or a Euclidean similarity metric.

20. The computer readable storage medium of claim 18, wherein the instructions further comprise:
storing, by the storage module, the generated vocal signature, such that the stored vocal signature is a reference vocal signature for the user.
